(19) United States
(12) Patent Application Publication
(10) Pub. No.: US 2007/0110491 A1
(43) Pub. Date: May 17, 2007

(54) Method and apparatus adjusting the position of a printhead

(75) Inventor: Kris Vandermeulen, Bornem (BE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DYMO, Sint-Niklaas (BE)

(21) Appl. No.: 10/580,900

(22) PCT Filed: Nov. 24, 2004
(86) PCT No.: PCT/EP04/13546

§ 371 Date: Dec. 5, 2006

(30) Foreign Application Priority Data
Nov. 27, 2003 (GB) 0327609.4

(51) Int. Cl. B41J 11/20

(52) U.S. Cl. 400/55

(57) ABSTRACT

A printhead assembly including a printhead arranged to print on an image-receiving substrate; a platen; a fixed support; a first frame slideably connected to said fixed support, one of said printhead and said platen being mounted on said first frame; and a driver for driving said first frame relative to said fixed support to cause the one of said printhead and platen to move in a linear direction toward the other.

The present invention relates to a method of printing on an image receiving medium, such as a tape, and to a thermal printer and printhead arrangement to be used in such a method. In particular, the present invention relates to adjusting the position of a printhead.

Thermal printers are known. The printhead for such printing apparatus generally comprises a plurality of printing elements which are selectively activated, that is heated. An image is generated in one of two ways. An intermediate ink ribbon can be provided so that when the activated printing elements of the printhead heat up the ink from the parts of the ink ribbon in contact with the heated printing elements is transferred to the image receiving tape. Alternatively, the heated printing elements may directly contact a thermally sensitive image receiving tape which causes an image to be formed thereon by thermal activation.

In order to print an image the image receiving tape is passed through a print zone defined by the printhead and a platen which supports the image receiving medium during printing. The gap between the printhead and the platen defining the print zone allows the image receiving tape to pass through the print zone, whilst allowing the printhead to contact the image receiving tape in order to print an image on the tape.

Image receiving tapes are made of various types of material, having various thicknesses that are best suited to their application. Image receiving tape of different types of material can require the printhead to exert different pressures on the tape in order to print an image on the tape. Furthermore, it is necessary for the printing device to allow image receiving tapes of different thicknesses to pass through the print zone whilst allowing the printhead to contact the image receiving tape.

EP 1066975 (Brady) discloses an arrangement whereby a pivotally mounted printhead exerts pressure on the platen to provide a variable platen pressure when the print head thermally transfers ink from an ink ribbon to a labelling media. However, when used with labelling media of various thicknesses, a pivotally mounted printhead will contact the labelling media at different angles, depending on the thickness of the media, causing a misalignment between the printing area of the printhead and the labelling media.

It is therefore an object of the present invention to provide a printer for printing on image receiving mediums of different materials and of different thicknesses, and to overcome the problems presented by the prior art.

According to a first aspect of the present invention there is provided a printhead assembly comprising: a printhead arranged to print on an image receiving means; a platen; a fixed support; a first frame slideably connected to said fixed support, one of said printhead and said platen being mounted on said first frame; and driving means for driving said first frame relative to said fixed support to cause the one of said printhead and platen to move in a linear direction toward the other.

According to a second aspect of the present invention there is provided a printhead assembly comprising: a printhead arranged to print on an image receiving means; a platen; a fixed support; a first frame slideably connected to said fixed support, one of said printhead and said platen being mounted on said first frame; and driving means for driving said first frame relative to said fixed support in accordance with information stored with said image receiving means, to cause the one of said printhead and platen to move in a linear direction toward the other.

According to a third aspect of the present invention there is provided a printer comprising: inputting means for inputting data; a printhead arranged to print on an image receiving means; a platen; a fixed support; a first frame slideably connected to said fixed support, one of said printhead and platen being mounted on said first frame; and driving means for driving said first frame relative to said fixed support to cause the one of said printhead to move in a linear direction toward the other.

According to a fourth aspect of the present invention there is provided a method of controlling a printhead assembly comprising: a printhead arranged to print on an image receiving means; a platen; a fixed support; and a first frame slideably connected to said fixed support, one of said printhead and said platen being mounted on said first frame; wherein said method comprises the steps of driving said first frame relative to said fixed support to a predetermined position.

According to a fifth aspect of the present invention there is provided a method of printing with a printer comprising: inputting means for inputting data; a printhead arranged to print on an image receiving means; a platen; a fixed support; a first frame slideably connected to said fixed support, one of said printhead and platen being mounted on said first frame; wherein said method comprises the steps of driving said first frame relative to said fixed support to a predetermined position; and

printing on said image receiving means in accordance with said inputted data.

For a better understanding of the present invention, and to show how the same may be carried into effect, reference will now be made by way of example to the accompanying drawings in which:—

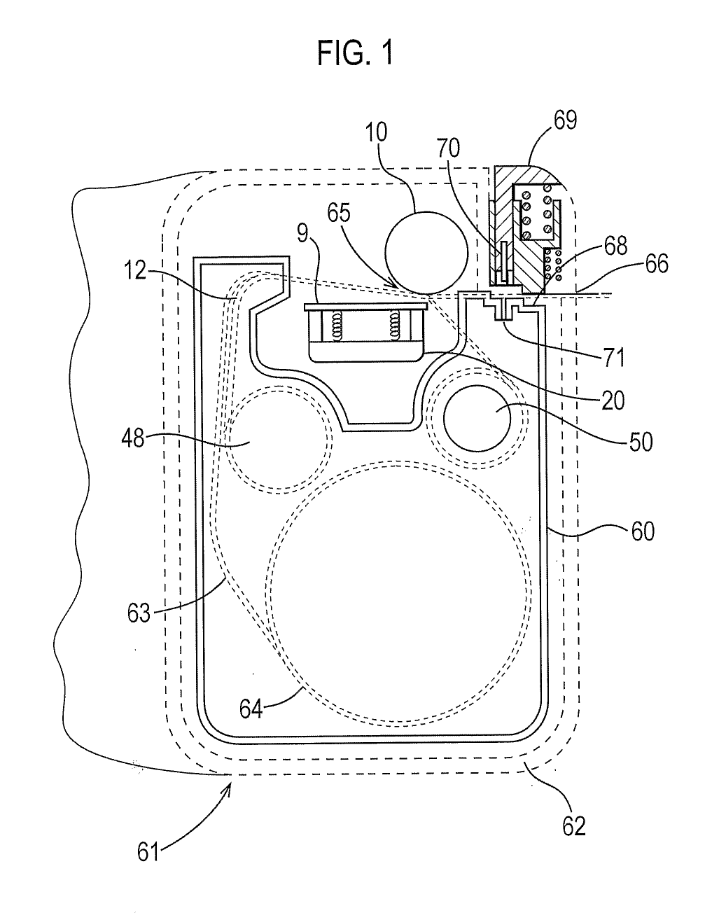

FIG. 1 is a schematic cross sectional view of a tape printing device embodying the present invention;

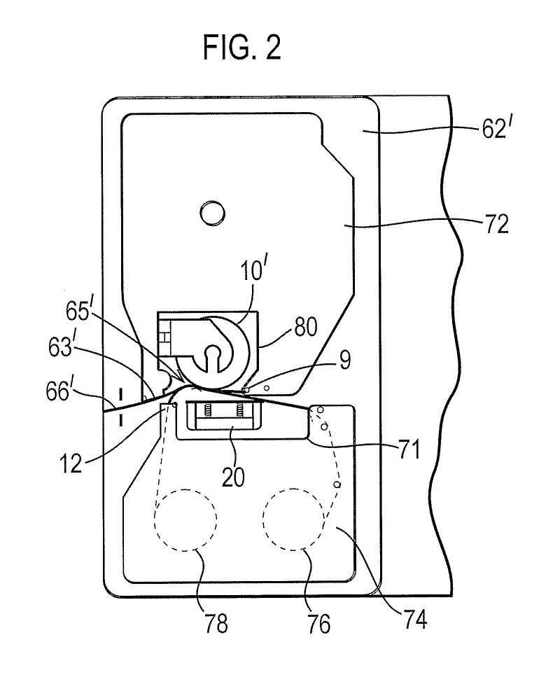

FIG. 2 is a schematic cross sectional view of a tape printing device in accordance with an alternative embodiment of the present invention.

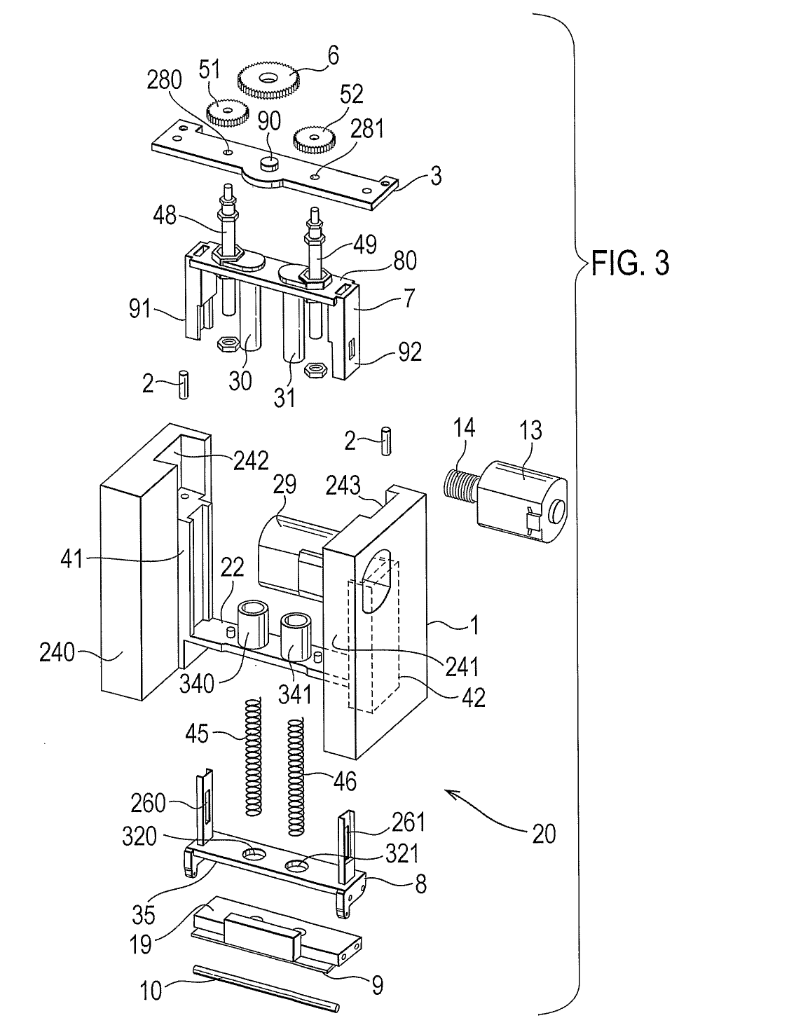

FIG. 3 is a diagram of an adjustable printhead arrangement in accordance with an embodiment of the present invention.

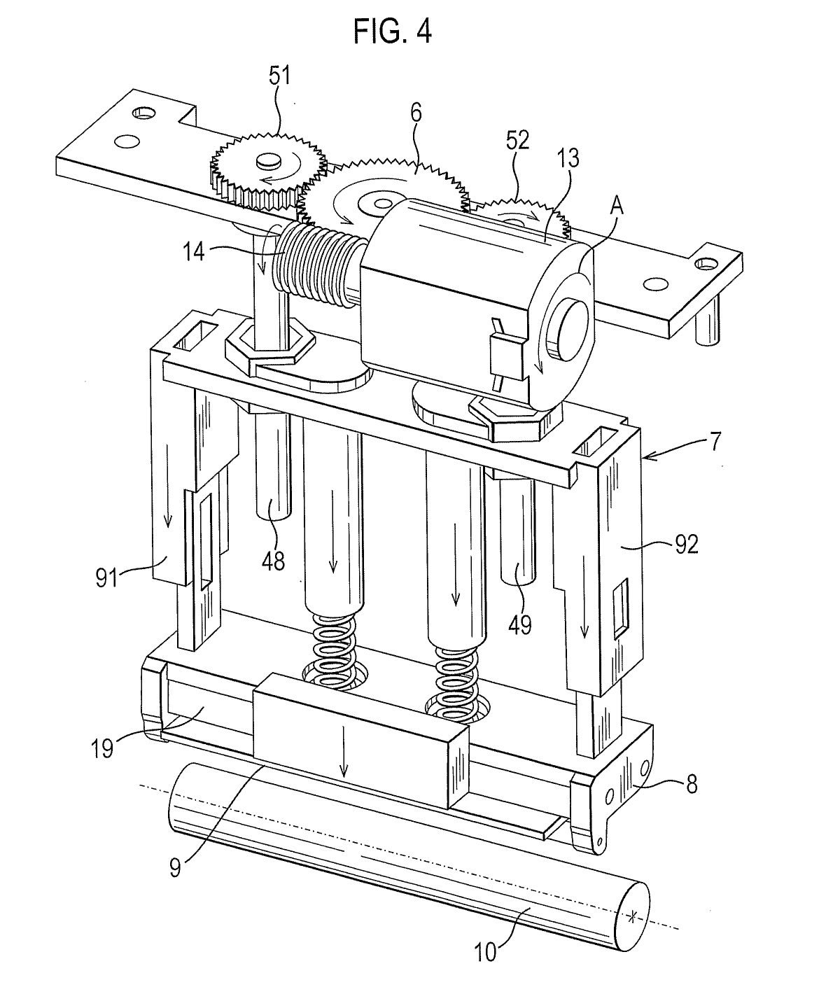

FIG. 4 is a diagram of an adjustable printhead arrangement in accordance with an embodiment of the present invention.

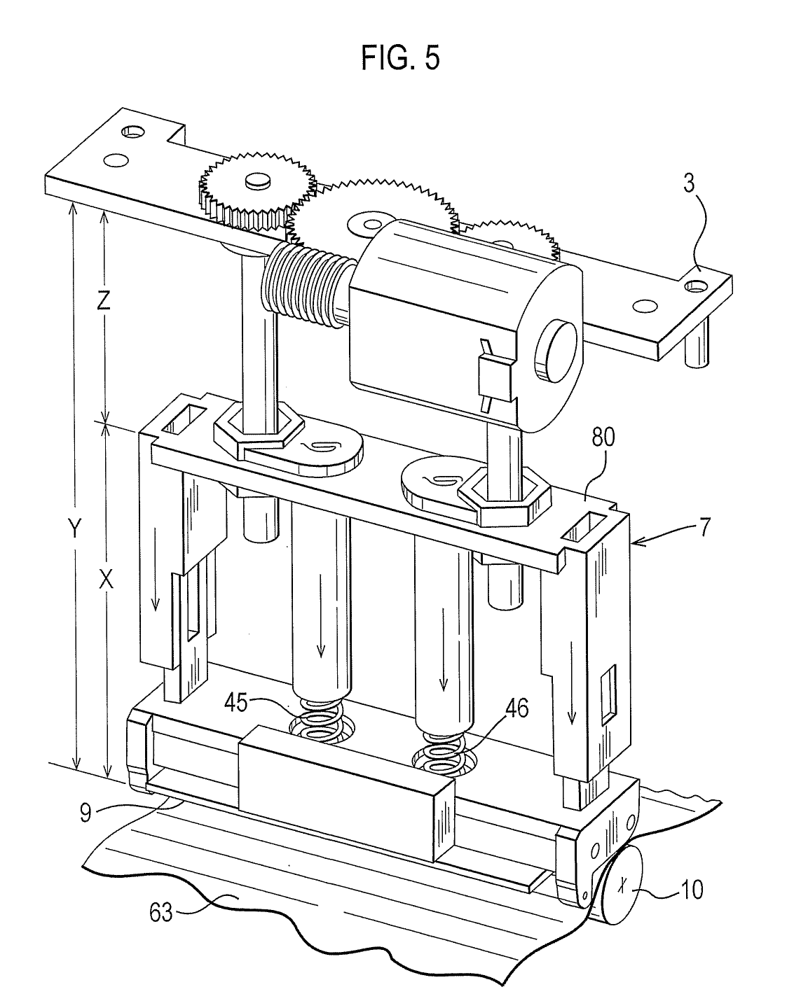

FIG. 5 is a diagram of an adjustable printhead arrangement in accordance with an embodiment of the present invention.

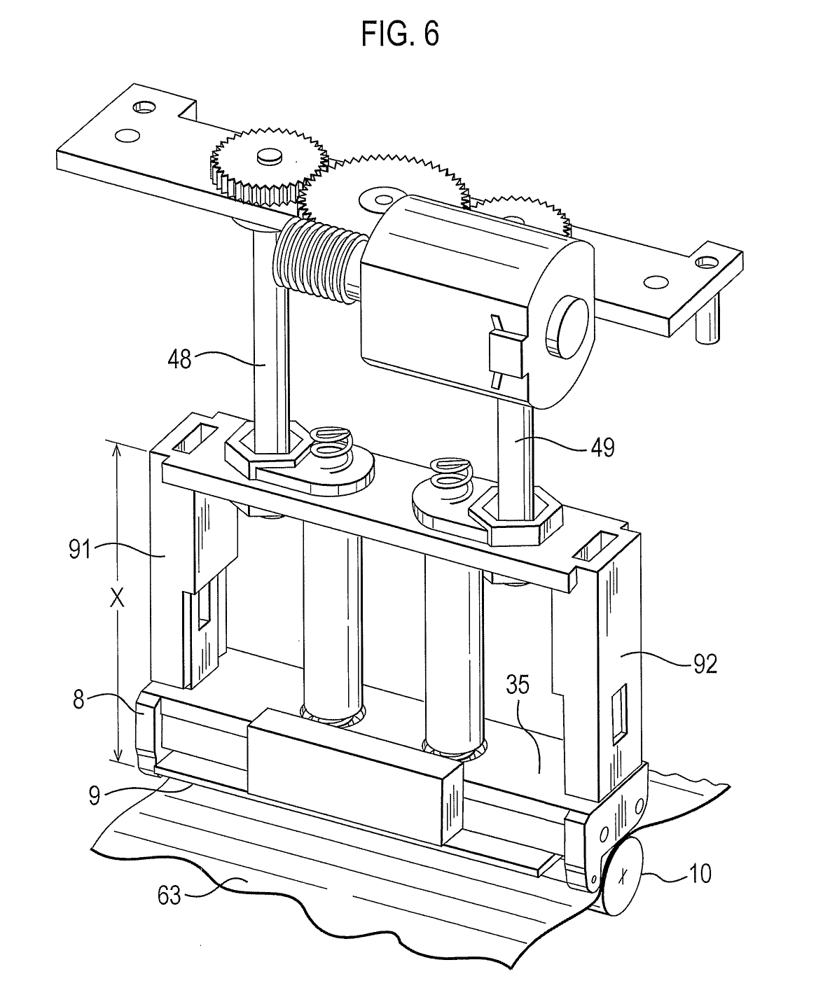

FIG. 6 is a diagram of an adjustable printhead arrangement in accordance with an embodiment of the present invention.

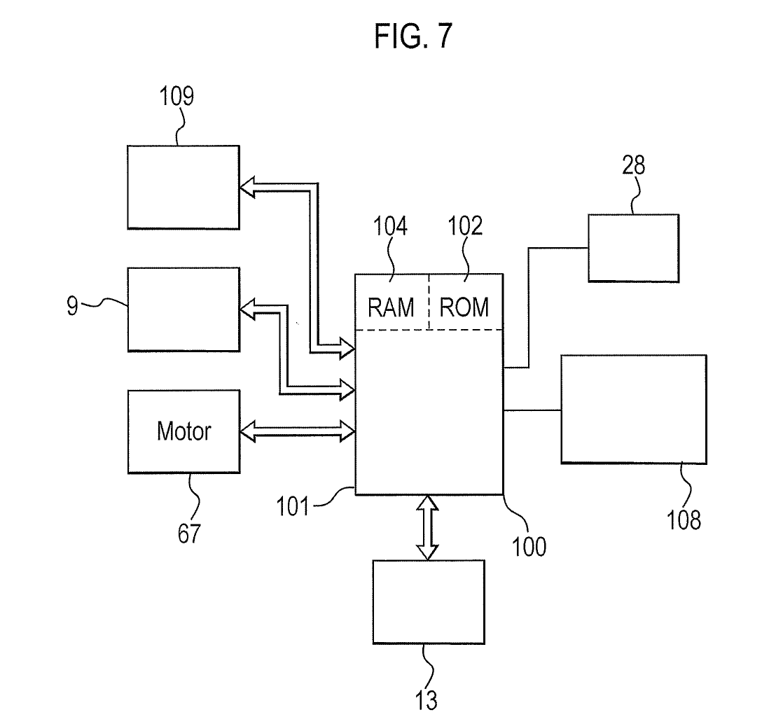

FIG. 7 is a diagrammatic sketch showing control circuitry for the printing device of FIG. 1 according to an embodiment of the present invention.

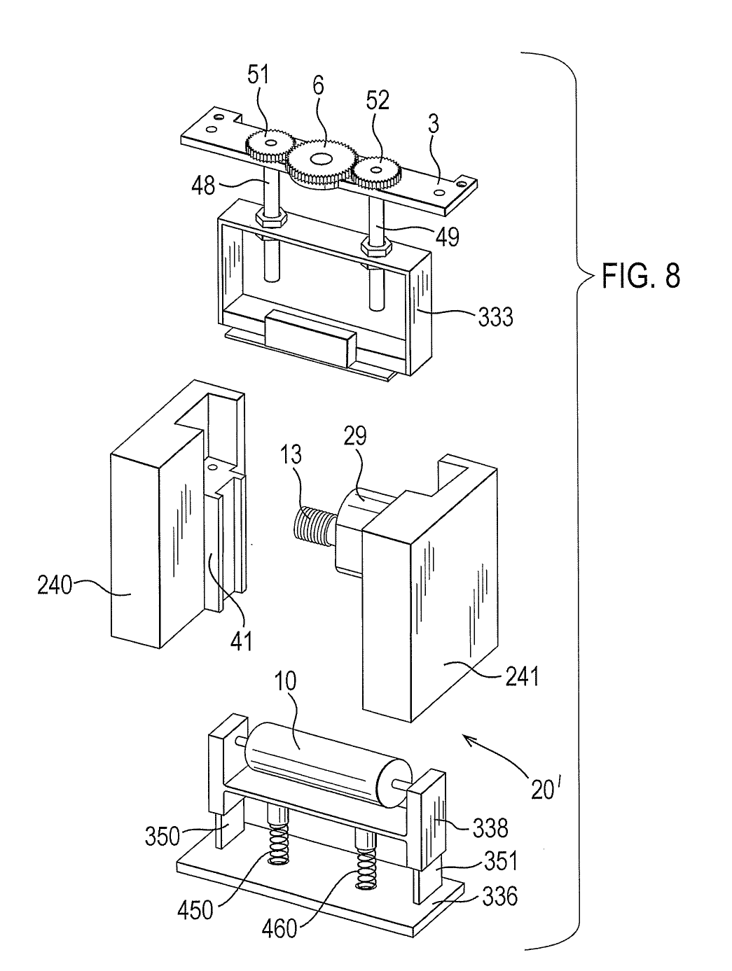

FIG. 8 is a diagram of an adjustable printhead arrangement in accordance with an alternative embodiment present invention.

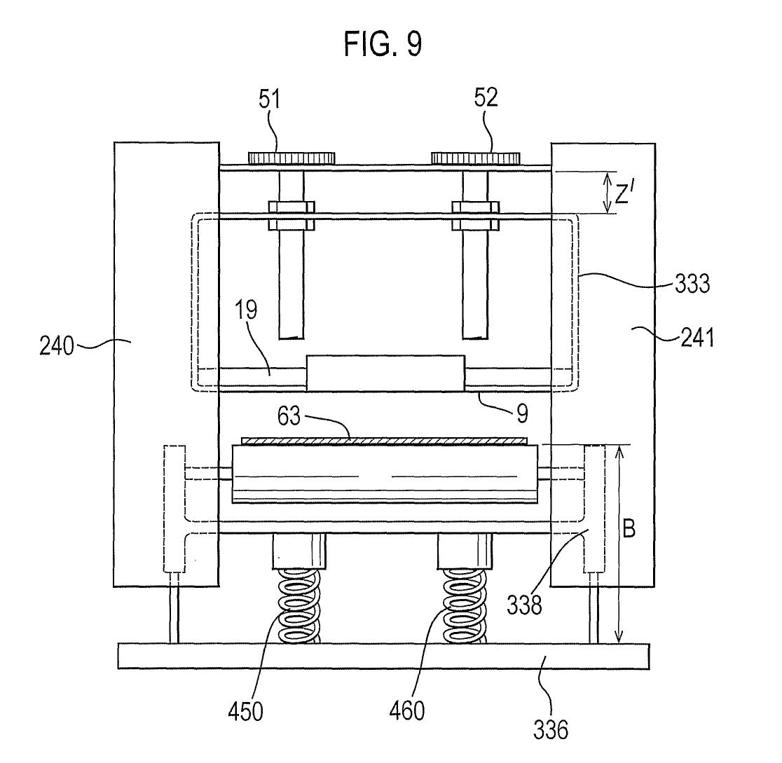

FIG. 9 is a diagram of an adjustable printhead arrangement in accordance with an alternative embodiment of the present invention.

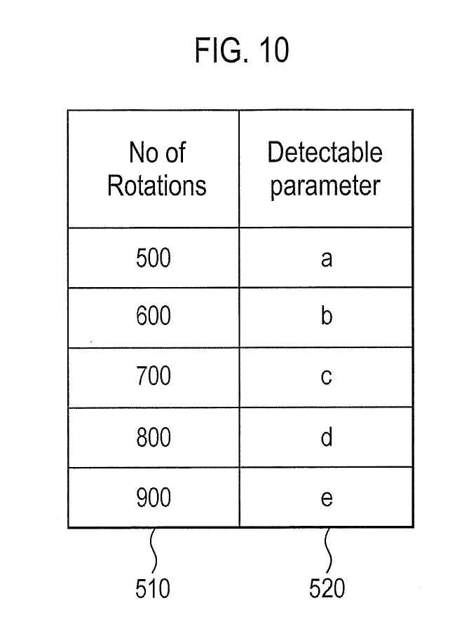

FIG. 10 is a diagram of a look up table in accordance with an embodiment of the present invention.

FIG. 1 shows in plan view a tape printing device 61 embodying the present invention which has a cassette 60 arranged therein. Typically this tape printing device 61 is a hand-held or small desktop device. The cassette 60 is located in a cassette bay 62 and contains a supply spool 64 of image receiving tape 63. The cassette bay 62 also accommodates a thermal print head 9 and a platen 10 which cooperate to define a print zone 65. The cassette 60 also has an ink ribbon supply spool 48 and an ink ribbon take up spool 50. An ink ribbon 12 is guided from the ink ribbon supply spool 48 through the print zone 65 and taken up on the ink ribbon take up spool 50. The image receiving tape 63 passes in overlap with the ink ribbon 12 through the print zone 65 with its image receiving layer in contact with the ink ribbon 12. The print head 9 is connected to an adjustable printhead arrangement 20, in accordance with an embodiment of the present invention, which will be discussed in more detail hereinafter. The adjustable printhead arrangement 20 is movable so that it can be brought into contact with the platen 10 for printing and moved away from the platen 10 to enable the cassette 60 to be removed and replaced. In the operative position, the platen 10 is rotated to cause the image receiving tape 63 to be driven past the print head 9 and the print head is controlled to print an image on the image receiving tape 63 by thermal transfer of ink from the ink ribbon 12. The printhead 9 comprises a thermal print head having an array of printing elements, each of which can be thermally activated in accordance with the desired image to be printed.

The platen 10 is driven by a DC motor or stepper motor 67 (see FIG. 7) so that it rotates to drive the image receiving tape 63 through the print zone 65 of the tape printing device 61 during printing. In this way, an image is printed on the tape and fed out from the print zone 65 to an outlet 66 of the tape printing device 61.

The image is printed by the print head 9 on the image receiving tape 63 on a column by column basis with the columns being adjacent one another in the direction of movement of the tape 63. Pixels are selectively activated in each column to construct an image in a manner well known in the art. The motor 67 may be provided with a shaft encoder for monitoring the speed of rotation of the motor. Sequential printing of the columns of pixels by the printhead 9 is controlled in dependence on the monitored speed of rotation of the motor 67. The control of the speed of the motor 67 is achieved by the microprocessor chip 100 (see FIG. 7) to generate data strobe signals each of which causes a column of pixel data to be printed by the print head 9.

The tape printing device 61 may include at cutting location 68 a cutting mechanism 69 which carries a blade 70. The blade 70 cuts the image receiving tape 63 then enters a slot 71 located in the cassette 60.

FIG. 2 shows an alternative embodiment of the present invention. FIG. 2 shows a printer having two cassettes arranged in a cassette receiving bay 62′ of a printing device. The upper cassette 72 contains a supply of the image receiving tape 63′ which passes through a print zone 65′ of the printer to an outlet 66′ of the printer. The image receiving tape 63′ comprises an upper layer for receiving a printed image on one of its surfaces. In one embodiment, image receiving tape 63′ has on its other surface an adhesive layer to which it is secured to a releasable backing layer. In such an embodiment a portion of the tape may be applied to a surface as an adhesive label. Alternatively the image receiving tape 63′ may not have an adhesive layer and portions of the tape may be applied to articles using plastic tags or the like. The cassette 72 has a recess 80 for accommodating a platen 10′ of the printer. The platen 10′ is mounted for rotation.

The lower cassette 74 contains an ink ribbon 12 which extends from a supply spool 76 to a take up spool 78 within the cassette 74. The thermal transfer ribbon 76 extends through the print zone 65′ in overlap with the image receiving tape 63′. The cassette 74 has a recess 71 for receiving the adjustable printhead arrangement 20 of the printer. The print head 9 is movable between an operative position, in which it bears against the platen and holds the ink ribbon 12 and the image receiving tape 63′ in overlap between the print head 9 and the platen 10 and an inoperative position in which it is moved away from the platen to release the ink ribbon 12 and the image receiving tape 63′. In the operative position the platen 10 is rotated under the action of a motor 67, shown in FIG. 7, in a manner as described in relation to FIG. 1. The print head is controlled to print an image onto the image receiving tape by thermal transfer of ink from the ribbon.

The ink ribbon 12 can be omitted in certain embodiments where the image receiving tape is of a thermally sensitive material. In this case, the image is printed by the thermal printhead directly onto the thermally sensitive image receiving tape.

The adjustable printhead arrangement 20, in accordance with a first embodiment of the invention will now be described in relation to FIG. 3. FIG. 3 shows an exploded view of the adjustable printhead arrangement 20. The adjustable printhead arrangement comprises a frame 1 comprising two parallel supports 240 and 241 interconnected by an interconnecting section 22. The internal walls of supports 240 and 241 of frame 1 have opposing recesses 242 and 243 in which two slotted support members 41 and 42 are formed. Support member 42 is shown as a dotted line visible through support 241. Support member 241 further comprises a motor housing 29 having an opening on the external wall of the support member 241, said housing extending toward the opposite support member 240.

Interconnecting section 22 is located between supports 240 and 241. Interconnecting section 22 comprises two cylindrical tubes 340 and 341 through which two springs 45 and 46 are located.

The adjustable printhead arrangement further comprises a printhead support 8 for supporting the printhead holder 19 and printhead 9. The printhead support 8 comprises two parallel projections 260 and 261 provided at each end of a plate 35. Plate 35 comprises two holes 320 and 321 through which the end of springs 45 and 46 are inserted. Printhead holder 19 is connected to the underside of plate 35 such that the ends of springs 45 and 46 are in contact with the printhead holder 19. Printhead 9 is glued to the underside of printhead holder 19. The two parallel projections 260 and 261 of printhead support 8 are slideably connected with slotted support members 41 and 42 of frame 1 such that plate 35 of the printhead support printhead holder 19 and printhead 9 may be moved toward and away from interconnecting section 22 of the frame 1.

The adjustable printhead arrangement 20 further comprises print head actuation frame 7 comprising a plate 80 and two parallel receiving portions 91 and 92 disposed at either end of said plate 80 for receiving said two parallel projections 260 and 261 of the print head support. Two threaded spindles 48 and 49 extend through two holes in the top plate 80 of print head actuation frame 7. Two nuts threaded onto each spindle connect each spindle to the top plate 80 such that, for each spindle, one nut is arranged above the top plate 80 and one nut is arranged below the top plate. This arrangement allows the printhead actuation frame to move along the axis of the spindle, by turning the spindle relative to the nut. Printhead actuation frame 7 is arranged to fit between the supports of frame 1 such that the parallel receiving portions 91 and 92 of printhead actuation frame 7 are slideably mounted within the two slotted support members 41 and 42 of frame 1.

A printhead cover 3 is fixedly mounted on top of slotted support members 41 and 42 of frame 1 by adjustable pins 2. The upper ends of spindles 48 and 49 project through two holes 280 and 281 in printhead cover 3. Two circular toothed gears 51 and 52 are connected to the projecting ends of spindles 48 and 49 respectively, such that gears 51 and 52 are disposed over printhead cover 3. In a preferred embodiment of the present invention toothed gears 51 and 52 are each 40 teeth gears. Drive gear 6 is arranged to rotate on spindle 90 which is positioned on the printhead cover 3 between gears 51 and 52 such that drive gear 6 interconnects with both gears 51 and 52.

A motor 13 is arranged in the motor housing of support member 241. Motor 13 is arranged to drive a worm gear 14 which interconnects with drive gear 6.

Printhead actuation frame 7 further comprises two hollow cylindrical members 30 and 31 which extend below the top plate 80 of the printhead actuation frame 7. The two cylindrical members 30 and 31 are arranged to receive the two springs 45 and 46 which extend from the printhead holder 19, through holes 320 and 321 of plate 35 and through cylindrical tubes 340 and 341 of interconnecting section 22.

The operation of the adjustable printhead arrangement in accordance with a preferred embodiment of the invention will now be discussed in relation to FIG. 4. When motor 13 is driven in a counter clockwise direction denoted by arrow A, the worm gear 14 rotates drive gear 6 such that gears 51 and 52 rotate in a clockwise direction. Rotating gears 51 and 52 in a clockwise direction rotates spindles 48 and 49 in a clockwise direction causes the nuts attached to the printhead actuation frame to move downwards along the axis of the spindles.

This causes the parallel receiving members 91 and 92 of printhead actuation frame 7 to move along the slotted support members 41 and 42 of interconnecting section 22. Printhead actuation frame 7, the printhead support frame 8, the printhead holder 19 and the printhead 9 are therefore slideably driven downwards relative to frame 1, toward platen 10. The motor 13 is provided with a shaft encoder for monitoring the number of rotations of the motor. The control of the number of rotations of the motor 13 is achieved by the microprocessor chip 100 (see FIG. 7) to drive the printhead actuation frame along a predetermined distance.

Reference will now be made to FIG. 5. FIG. 5 shows the printhead 9 in contact with the image receiving tape 63 on the platen roller 10.

The distance between the printhead 9 and the printhead cover 3 is denoted by distance Y. Distance Y increases as the print head is moved towards the platen. The maximum value of distance Y between the print head cover 3 and the printhead 9 will be when the printhead 9 contacts the image receiving tape and will therefore depend on the thickness of the image receiving tape.

Since the printhead cover is fixedly connected to the slotted support members 41 and 42, the distance between the printhead cover 3 and the platen 10 is fixed. Therefore, the maximum value of distance Y will not exceed the fixed distance between the printhead cover 3 and the platen 10. For image receiving tapes of negligible thickness the maximum value of Y will be equal to the fixed distance between the printhead cover 3 and the platen 10.

At the point when the print head 9 contacts the image receiving tape, springs 45 and 46 are under a minimum amount of compression. Accordingly, the distance between printhead 9 and plate 80 of printhead actuation frame 7, denoted by distance X, will be at a maximum. The distance travelled by the printhead actuation frame is denoted by reference Z.

As the motor continues to drive the printhead actuation frame 7 toward the platen 10, the springs 45 and 46 are placed under increasing compression between the printhead, which is prevented by the platen from moving, and plate 80 of the printhead actuation frame 7, which continues to move toward the platen. As the distance X between the printhead and plate 80 decreases, the pressure applied to the image receiving tape by the printhead increases. The pressure applied to the image receiving tape can therefore be said to be a function of X. Or,
P=f(−X)
where P is the pressure applied to the image receiving tape by the printhead.

Since:
Y=Z+X
therefore,
P=f(Z−Y)

Since Y is dependent only on the thickness of the image receiving tape, for each printing operation on a particular thickness of tape, Y is fixed and the pressure applied to the image receiving tape varies as a function of Z. Therefore, the pressure applied to the image receiving tape can be directly calculated for known values of the position of the printhead actuation frame and the thickness of the image receiving tape.

FIG. 6 shows a diagram of the adjustable printhead arrangement with the printhead actuation frame 7 wound to the end of spindles 48 and 49. Plate 35 of the printhead support frame 8 abuts the parallel receiving members 91 and 92 of the printhead actuation frame. In this position the distance travelled by the printhead actuation frame, and thus the value of Z, is a maximum. The springs 45 and 46 cannot be compressed any further and thus the printhead applies a maximum pressure to the image receiving tape.

In an alternative embodiment of the present invention the printhead actuation frame is fixed relative to the printhead support frame and the springs 48 and 49 are omitted. In this embodiment the motor 13 drives the printhead toward and away from the platen, to operative and inoperative positions respectively. Thus in this embodiment the distance X between the printhead 9 and plate 80 of the printhead actuation frame is fixed.

Reference is now made to FIG. 8. FIG. 8 shows an adjustable printhead arrangement 20′ in accordance with a further embodiment of the present invention. Components of the arrangement that are the same as those described in relation to FIG. 3 are referred to with like reference numerals. In this arrangement the printhead support frame 8 and the printhead actuation frame 7 shown in FIG. 3 have been replaced with a fixed printhead actuation and support frame 333. Since this is a single frame, compression springs 45 and 46, cylindrical members 30 and 31 and interconnection section 22 are omitted.

In this embodiment of the invention the platen 10 is compressibly supported relative to the printing device. Platen 10 is supported on a platen support frame 338. Platen support frame 338 and printhead actuation frame 333 are slideably connected within the two slotted support members 41 and 42. Platen support frame 338 is slideably mounted on platen base plate 336, on projections 350 and 351. Springs 450 and 460 are attached between the platen base plate 336 and the underside of a centre section of platen support frame 338.

Reference is now made to FIG. 9. The print head is moved toward the platen by the rotation of motor 13. The distance travelled by printhead actuation frame 333 is denoted by distance Z′. Distance Z′ increases as the print head is moved towards the platen. The springs are placed under compression by the movement of the printhead actuation frame when the printhead contacts the image receiving tape. The position of the printhead actuation frame when the printhead contacts the image receiving tape will depend on the thickness of the image receiving tape. The position of the platen when the springs are uncompressed will be referred to as the resting position of the platen.

At the point when the print head contacts the image receiving tape on the platen, springs 450 and 460 are under a minimum amount of compression. Accordingly, the distance between platen and the platen base plate 336, denoted by distance B, will be at a maximum.

As the motor continues to drive the printhead support frame 333 towards the platen 10, the springs 450 and 460 are placed under increasing compression between the movable platen and the base plate 336. As the distance B between the platen 10 and the base plate 336 decreases, the pressure applied to the image receiving tape by the printhead increases. The pressure applied to the image receiving tape can therefore be said to be a function of B. Or,
P=f(−B)
where P is the pressure applied to the image receiving tape by the printhead.

After the point where the printhead contacts the image receiving tape, any further increase in distance Z′ will be equal to the decrease in distance B. Therefore when Z′ is greater than the value of Z at the point when the printhead contacts the image receiving tape, then,
P=f(Z′)

The value of distance Z′, at the point when the movement of the printhead causes the springs to be compressed, depends on the thickness of the image receiving medium. Therefore, the pressure applied to the image receiving medium and can be directly calculated for known values of the position of the printhead actuation frame (Z′) and the thickness of the image receiving tape.

It can therefore be seen that in the above embodiments, pressure can be directly calculated from the distance travelled by the printhead actuation frame and the thickness of the image receiving tape. Since the distance travelled by the printhead actuation frame is controlled by the rotation of the motor 13, it is therefore possible to control the pressure applied to the image receiving tape by controlling the number of rotations of the motor 13.

In an embodiment of the present invention information may be stored with the image receiving tape to indicate the required pressure to print an image on the image receiving tape. The information stored with the image receiving tape could be detectable with a detecting device located in the printing device. For example the information may be stored on an RFID device located on a cassette containing the image receiving tape and a transponder could be located in the printing device to detect the information stored on the RFID tag. In alternative embodiments of the invention, the information may be stored in a barcode on the cassette and read by a barcode reader installed in the printing device or on an electrically readable ROM chip located on the cassette.

In one embodiment of the invention the information stored with the image receiving tape may specify the pressure required to print on the image receiving tape. Additionally, or alternatively, information relating to the thickness of the tape could be provided. This information may either be stored with the image receiving tape, or input by the user. In a preferred embodiment of the invention the printing device may be arrange to print on image receiving tapes that range between 0.13 mm to 1 mm in thickness. Information relating to the specified pressure, or tape thickness, could then be used to control the action of the adjustable printhead described herein after.

In an embodiment of the invention information stored on the printing device is used to directly control the position of the adjustable printhead.

The control of the adjustable printhead will now be described with relation to FIG. 7. FIG. 7 shows the basic circuitry for controlling the printing device 1. There is a microprocessor 100 chip having a read only memory (ROM) 102, a microprocessor 101 and random access memory capacity (RAM) 104. The microprocessor chip 100 outputs data to drive a display via a display driver chip 109 to display a label to be printed (or part thereof) and/or a message for the user. The display driver alternatively may form part of the microprocessor chip. The microprocessor receives an input from keyboard 108. Additionally, the microprocessor chip 100 also outputs data to drive the printing elements of the print head 9 to form a label. The microprocessor chip 100 also controls the DC motor 67 driving the platen 10 and the motor 13 for driving the adjustable print head arrangement. In an alternative embodiment of the present invention a separate microprocessor chip may control the motor 13. The microprocessor may also control the cutting mechanism 28 to allow lengths of tape to be cut off.

As previously described, the motor 13 is provided with a shaft encoder for monitoring the number of rotations of the motor such that the distance the printhead actuation frame is driven can be controlled by the microprocessor 100.

According to one embodiment of the present invention a look up table stored in the ROM may be used to determine the number of rotations and thus the distance the printhead actuation frame is driven. As shown in FIG. 10, the look up table stores a list of motor rotations in column 510 that correspond to a detectable parameter of the image receiving tape stored in column 520.

In one embodiment of the invention the detectable parameter may be the tape thickness. The number of motor rotations required to drive the printhead actuation means to provide a predetermined pressure on a particular tape thickness can be stored in correspondence with the tape thickness in the look up table. Separate look up tables may be stored in the ROM for each different type of material to be used with the printing device that requires a different printing pressure. The thickness of the tape and the material of the tape may be input by the user or may be sensed using a sensing arrangement described earlier.

In a preferred embodiment of the invention the detectable parameter may be an arbitrary value stored on the image receiving tape. The value specifies the number of rotations of the motor that are necessary for printing on the image receiving tape contained within the cassette at the required pressure. Since in this case the position of the printhead actuation frame for printing on the material has been precalculated by the manufacture, to take into account the type of material and the thickness of the image receiving tape, the printing device does not require any further information to print on the tape. In one embodiment of the invention the value may specify the number of rotations of the motor by means of a look up table as described in relation to FIG. 10. In an alternative embodiment of the invention the value may be used in an algorithm stored in the ROM to calculate the number of rotations of the motor.

In a further embodiment of the present invention the position of the printhead actuation frame may be calculated using an algorithm stored in the ROM of the microprocessor. As previously stated, pressure can be directly calculated from the position of print actuation frame and the thickness of the image receiving tape. Since different pressures are required for different image receiving tapes, different algorithms may be stored in the ROM, to be used when different image receiving tapes are installed in the printer.

In a preferred embodiment of the present invention the printer device is provided with a printhead actuation frame home switch which causes the printhead actuation frame to return to a reference position. The home switch may be operated to allow the user to remove the image receiving tape. The home switch may also be operated in the event of a power failure, such that the position of the printhead actuation frame can be relocated at the reference position.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1.-13. (canceled)

14. A printhead assembly comprising:
a printhead arranged to print on an image-receiving substrate;
a platen;
a support;
a first frame slideably connected to said support, one of said printhead and said platen being mounted on said first frame;
a driver for driving said first frame relative to said support to cause the one of said printhead and platen to move in a linear direction toward the other; and
a compressor arranged to exert a biasing force on one of said printhead and said platen, when said driver drives said first frame relative to said support.

15. The printhead assembly of claim 14 wherein said compressor is disposed between the first frame and the printhead or platen, respectively.

16. The printhead assembly of claim 14 comprising a second frame, the other one of the printhead and platen being mounted on said second frame.

17. A printhead assembly of claim 16 wherein said compressor is arranged so as to compressibly support the second frame.

18. The printhead assembly of claim 14 comprising a third frame slideably connected to said support wherein the compressor is connected between said first and third frames.

19. The printhead assembly of claim 18 wherein the driver drives said third frame together with said first frame, relative to said support.

20. The printhead assembly of claim 18 wherein, when the printhead is mounted on the first frame the driver is arranged to drive the third frame toward the first frame when said print head abuts the image-receiving substrate, causing the compressor to be compressed.

21. A printhead assembly of claim 16 wherein, when the printhead is mounted on the first frame, driving the first frame relative to the support causes the compressor to be compressed when the print head abuts said image-receiving substrate.

22. A printhead assembly comprising:
a printhead arranged to print on an image-receiving substrate;
a platen;
a support;
a first frame slideably connected to said support, one of said printhead and said platen being mounted on said first frame; and
a driver for driving said first frame relative to said support in accordance with information stored with said image receiving substrate, to cause the one of said printhead and platen to move in a linear direction toward the other.

23. A printer comprising:
an input device for inputting data
a printhead arranged to print on an image-receiving substrate;
a platen;
a support;
a first frame slideably connected to said support, one of said printhead and platen being mounted on said first frame;
a driver for driving said first frame relative to said support to cause the one of said printhead to move in a linear direction toward the other; and
a compressor arranged to exert a biasing force on one of said printhead and said platen, when said driver drives said first frame relative to said support.

24. A printer of claim 23 wherein the first frame is driven to a predetermined position relative to said support in accordance with said input data.

25. A method of controlling a printhead assembly comprising:
a printhead arranged to print on an image-receiving substrate;
a platen;
a support;
a first frame slideably connected to said support, one of said printhead and said platen being mounted on said first frame; and
a compressor arranged to exert a biasing force on one of said printhead and said platen,
wherein said method comprise the steps of driving said first frame relative to said support to a predetermined position, and said compressor exerting a biasing force on one of said printhead and said platen wherein said first frame is driven relative to said support.
